(19) United States
(12) Patent Application Publication
(10) Pub. No.: US 2010/0104196 A1
(43) Pub. Date: Apr. 29, 2010

(54) Method and System for Extracting Information from an Analog Graph

(75) Inventors: Ivan E. Paez, New Berlin, WI (US); John F. Van Nortwick, Hartland, WI (US)

Correspondence Address: WHYTE HIRSCHBOECK DUDEK S.C.;INTELLECTUAL PROPERTY DEPARTMENT, 33 East Main Street, Suite 300, Madison, WI, 53703-4655, US

(73) Assignee: RAIR TECHNOLOGIES, LLC, Brookfield, WI (US)

(21) Appl. No.: 12/582,162

(22) Filed: Oct. 20, 2009

Related U.S. Application Data
(60) Provisional application No. 61/106,763, filed on Oct. 20, 2008.

(51) Int. Cl. G06K 9/46

(52) U.S. Cl. 382/195

(57) ABSTRACT

Disclosed herein is a method for extracting information from an analog graph on a driver log sheet. The method includes providing an electronic image of an analog graph, identifying a graph height dimension and a graph width dimension, dividing the height dimension into a number of activity rows, and dividing the width dimension into a number of time columns. An array of cells defined by the intersections of the time columns and the activity rows is established, where each cell includes a plurality of pixels. For each cell, a probability is determined corresponding to the probability that a substantially horizontal line formed by black pixels extends substantially across at least a portion of that cell. For each time column, the respective probabilities of the cells in that time column are compared, the cell with the highest probability is flagged, and the activity row of the flagged cell is determined.

### CROSS-REFERENCE TO RELATED APPLICATION

This application claims the benefit under 35 USC §119 (e) of U.S. Provisional Application No. 61/106,763, filed Oct. 20, 2008, the teachings and disclosure of which are incorporated herein by reference.

### BACKGROUND OF THE INVENTION

One significant safety factor in the transportation industry is the physical condition of the driver or operator. A tired driver is more likely to be inattentive or slower to react, thereby putting himself, his equipment, cargo, passengers, and nearby third parties at increased risk. In order to reduce this risk, laws have been passed which strictly regulate maximum driving and “on duty” time as well as minimum rest times. To ensure compliance with these laws, the individual driver must maintain a log (driver log sheet) each day documenting on duty time, driving time, and rest periods, among other statistics. Furthermore, the transportation company is obligated to ensure that all of their drivers comply with the regulations. Accordingly, the transportation company must compile, review, store, and report on the drivers' log sheets.

The transportation company's duties to ensure compliance through review of the individual logs can be very onerous for larger corporations. While some attempts have been made to automate the log review process, a number of difficulties still remain. These include the fact that most log sheets are recorded by hand on an analog type graph, and the resultant lines may not necessarily be straight, may not extend entirely across a desired area, may extend a bit into undesired areas, may be skewed, or may be otherwise imperfect, making some log sheets difficult to read and/or interpret. Further, a wide variety of formats for driver log sheets are commonly used in the industry. Accordingly, it would be advantageous if a method of automated graph analysis could be developed that overcame at least one or more of the above-described limitations.

### BRIEF SUMMARY OF THE INVENTION

In one embodiment, a method for extracting discrete driver input activity information from an analog graph on a driver log sheet is disclosed, the method including, providing an electronic image of at least a portion of the log sheet that includes the analog graph, identifying a graph height dimension and a graph width dimension, dividing the height dimension into a number of activity rows, with each activity row representing a respective activity performed by a driver, and dividing the width dimension into a number of time columns to represent a number of time frames for performing the activities, thereby establishing an array of cells defined by the intersections of the time columns and the activity rows, where each cell includes a plurality of pixels. The method further including, determining for each cell a probability that a substantially horizontal line formed by black pixels extends substantially across at least a portion of that cell, wherein the black pixels represent driver input activity information, and for each time column, comparing the respective probabilities of the cells in that time column, flagging the cell with the highest probability, and determining the activity row of the flagged cell, thereby determining which activity was performed in each time frame.

In another embodiment, a method of calculating a probability that a line extends through a portion of a graph is disclosed, the method including, providing at least a portion of a graph having a cell that includes a first array of pixels, where the first array has a plurality of first rows and a plurality of first columns, generating a second array having a plurality of units formed by intersecting second rows and second columns, wherein at least a portion of the units correspond with pixel locations in the first array, with the quantity of second rows being less than the quantity of first rows, and the quantity of second columns being less than the quantity of first columns. The further including, populating each unit in the second array with an indicator to identify if a black pixel is detected in the corresponding pixel location of the cell, and summing the number of black pixel indicators in each second row to determine the probability of a line.

In yet another embodiment, a computer system for extracting driver input activity information from an analog graph on a driver log sheet is disclosed, the system including, an input portion for receiving an electronic image of at least a portion of the log sheet that includes the analog graph, the image having a plurality of pixels, each pixel having an associated value, a processor portion for analyzing the pixel values of the image to determine the actual borders of the graph, and subsequently calculate a graph height dimension and a graph width dimension, wherein the height dimension is divided into a pre-determined number of activity rows to represent a number of possible activities performed by an operator and the width dimension is divided into a number of time columns to represent a number of time frames for performing the activities, thereby establishing a first array of cells defined by the intersections of the activity columns and the time rows, where each cell is populated with respective pixels, and wherein the probability that a substantially horizontal line formed by black pixels extends substantially across at least a portion of each cell is determined, and for each time column, the respective probabilities of the cells in that time column are compared, and the cell with the highest probability is flagged and the activity row of the flagged cell is determined, thereby determining which activity was performed in each time frame. The system further including an output portion for displaying or otherwise providing an accounting of the activity that was performed in each time frame.

### BRIEF DESCRIPTION OF THE DRAWINGS

Embodiments of the invention are disclosed with reference to the accompanying drawings and are for illustrative purposes only. The invention is not limited in its application to the details of construction or the arrangement of the components illustrated in the drawings. The invention is capable of other embodiments or of being practiced or carried out in other various ways. The drawings illustrate a best mode presently contemplated for carrying out the invention.

FIG. 1 is an exemplary driver log sheet that includes an analog graph that represents driver activity for a time period.

FIG. 2 is a flowchart showing an overview of the process for extracting graph data from an electronic representation of the driver log sheet of FIG. 1.

FIG. 3 is a flowchart showing the subprocess for identifying the left border of the graph.

FIG. 4 is a flowchart showing the subprocess for identifying the right border of the graph.

FIG. 5 is a flowchart showing the subprocess for identifying the top border of the graph.

FIG. 6 is a flowchart showing the subprocess for identifying the bottom border of the graph.

FIG. 7 is a flowchart showing the subprocess for adjusting the area of cells.

FIG. 8 is a flowchart showing the subprocess for capturing the probability of a line in the cells that comprise the graph.

FIGS. 9A-9D are flowcharts showing subprocesses for determining the relative amounts of black pixels in a cell.

FIG. 10 is a flowchart showing the subprocess for comparing the cells associated with a particular quarter hour.

FIG. 11 is an exemplary block diagram of the system.

### DETAILED DESCRIPTION OF THE PREFERRED EMBODIMENT

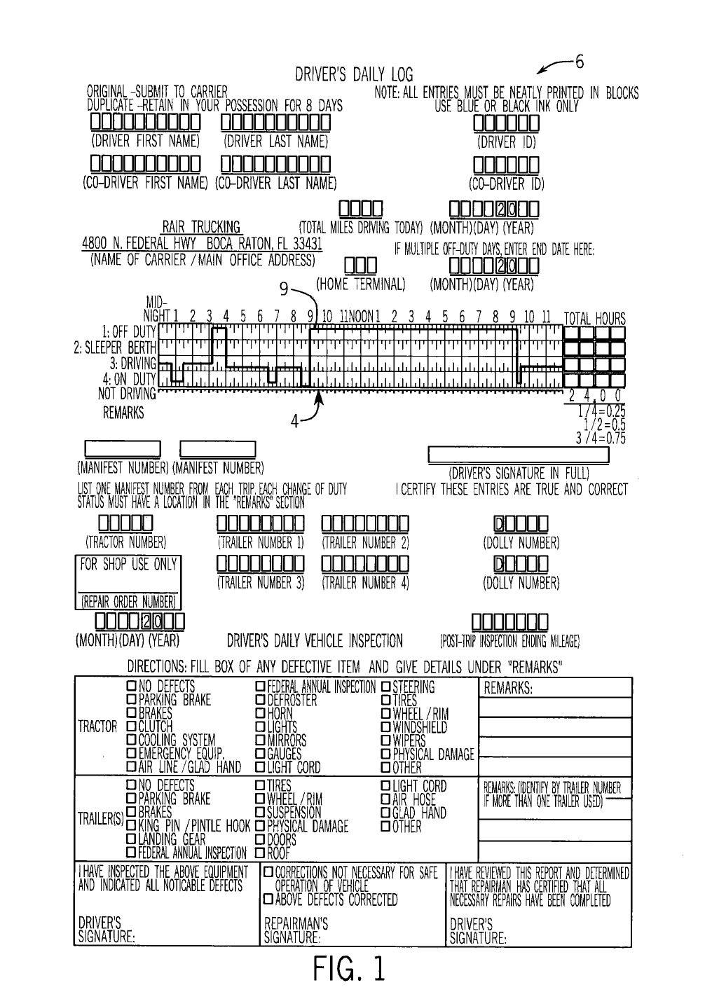

As a general overview, a method is described for automatically processing electronic image versions of driver log sheets in order to extract from each of these images graphical information which was input by the driver on the graph to indicate his or her activity, in order to determine what activity was performed in each time frame illustrated on the graph. Various different types of driver log sheets can be analyzed. A filled out driver log sheet is scanned to create an electronic image. Various preprocessing steps such as deskewing can be performed on the electronic image prior to analyzing it. Then the image is first analyzed to determine the location of the graph within the image. In this manner, the graph can be extracted from any of a variety of different log sheets. Once found, the electronic graph is divided into rows, one row for each possible activity, and then divided into columns, each column corresponding to a specific time frame. For example, for the graph illustrated in FIG. 1, the electronic graph is divided into four rows and 96 columns, each column designating a 15 minute time period of the 24 hour period represented by the graph. Dividing the graph into rows and columns generates a cell array. Each cell of the cell array includes a plurality of pixels each having an associated pixel value. Each cell is analyzed to strip away the information (those pixels) that represent part of the graph itself rather than the information input by the driver. Then the remaining information is analyzed to determine a probability that a line or portion of a line input by a driver exists in that cell, in order to determine whether an activity associated with the row of that cell was performed.

In the following discussion, many specific computational variables will be named in shorthand notation. BlackCount will refer to the pixel count for a given region of the graph as determined by the system. Prefixes “min”, “max”, and “cur” refer to minimum, maximum and current, relative to the variable they modify. Spelling variations of LeftBorder, RightBorder, TopBorder and BottomBorder represent variables that commonly refer to the respective edges of the graph or truncated version of the graph, where the graph includes an array of cells. X and Y refer to x-axis (or width) and y-axis (or height) of the graph. Cell refers to an area of the graph defined by specific X and Y values while Array refers to an overall grid composed of the individual cells.

More specifically, in at least one embodiment, the method for extracting information from an analog graph includes identifying the borders of the analog graph in an electronic image and forming a first array of cells situated inside the borders, wherein the cells each represent a particular activity along the y-axis at a particular quarter hour of time along the x-axis. Because the graph 4 includes a hand-drawn line 9, this hand-drawn line with be indicated by a series of black pixels throughout corresponding ones of the various cells. Additionally, second unit arrays are created and populated using a representative portion of the pixel information from each of the cells in the first array to identify if a corresponding pixel is black (designating a marking) or white. The second arrays are then analyzed to identify trends of black pixels that may construe a line that extends across at least a portion of each respective cell. The strength of the trends is determined and used to identify which cells along the y-axis include the strongest possibility for a line based on the black pixel count for each of the quarter hour increments along the x-axis. The y-axis location is then used to determine which activity along the y-axis has the highest probability for a line therein and a string character is stored identifying the activity for that time portion along the x-axis. The culmination of the string characters provides a representation of the entire line, and a total count or duration can also be provided for the amount of time that has been indicated for each activity.

For illustrative purposes, the invention will be described as analyzing an exemplary analog graph 4 from an operator's log sheet 6, as seen in FIG. 1, where the analog graph 4 has been converted to an electronic format for the analysis. Such a graph is normally divided along the x-axis into columns that represent quarter hour periods for the entire day (i.e., 96 quarter hour periods in a 24 hour day). The y-axis is divided into rows, (normally four rows) with each row representing a section that represents an activity performed by an operator, such as driving, on-duty but not driving, off-duty, and sleep periods. However, such graphs can vary in size, offering more or less activities and/or time divisions and therefore, alternative sectioning can be used for other applications including more or less rows and columns. The invention is intended to cover such alternative applications and sectioning.

Referring again to FIG. 1, the exemplary driver log sheet 6 is provided that includes the analog graph 4. The graph 4 includes 4 borders having a line 9 therein, where the line 9 was hand-drawn in by a driver to indicate one of four different activities (designated along a height, in rows) that were performed (in fifteen minute increments (designated along a width, in columns) throughout a 24-hour day.

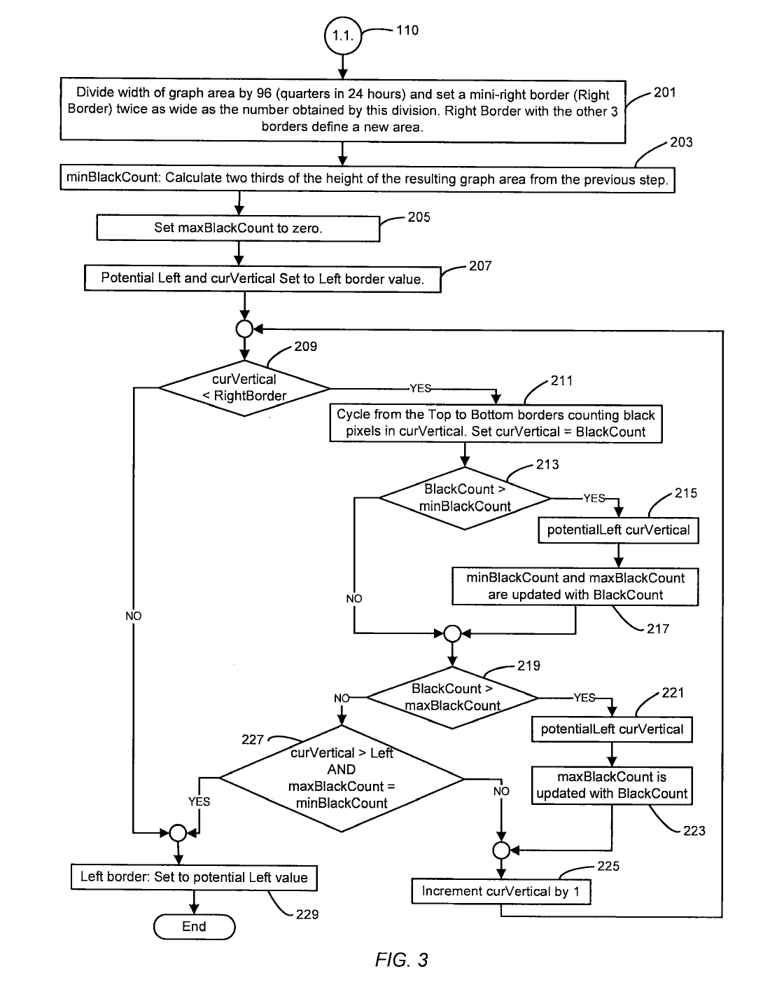

In the present embodiment, the log sheet 6 is scanned or otherwise converted from a paper document to an electronic document or image for analysis. The graph portion of the image is isolated from the log sheet 6 and communicated along with assumed pre-defined left, right, top and bottom borders. The pre-defined borders are assumed based on the placement of the image of the graph 4, although because the exact borders are preferred to limit errors, the locations of the actual borders are identified at step 11. Step 11 is broken up into subprocess step 110 to locate the Left border, step 120 to locate the Right border, step 130 to locate the Top border, and step 140 to locate the Bottom border. These subprocess steps are discussed in more detail below with reference to FIGS. 3-6.

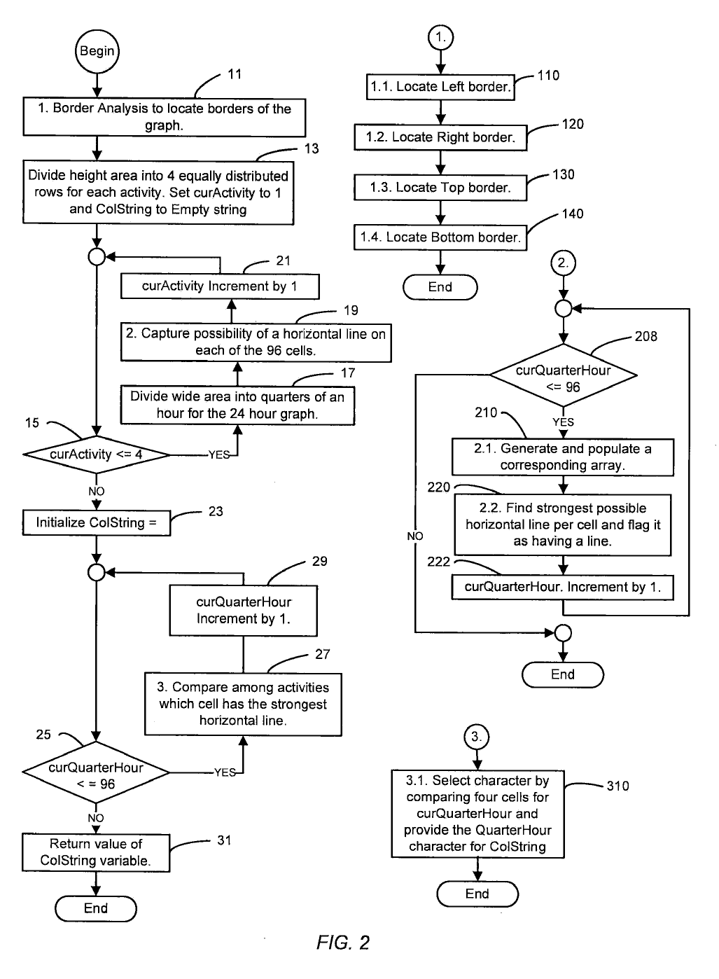

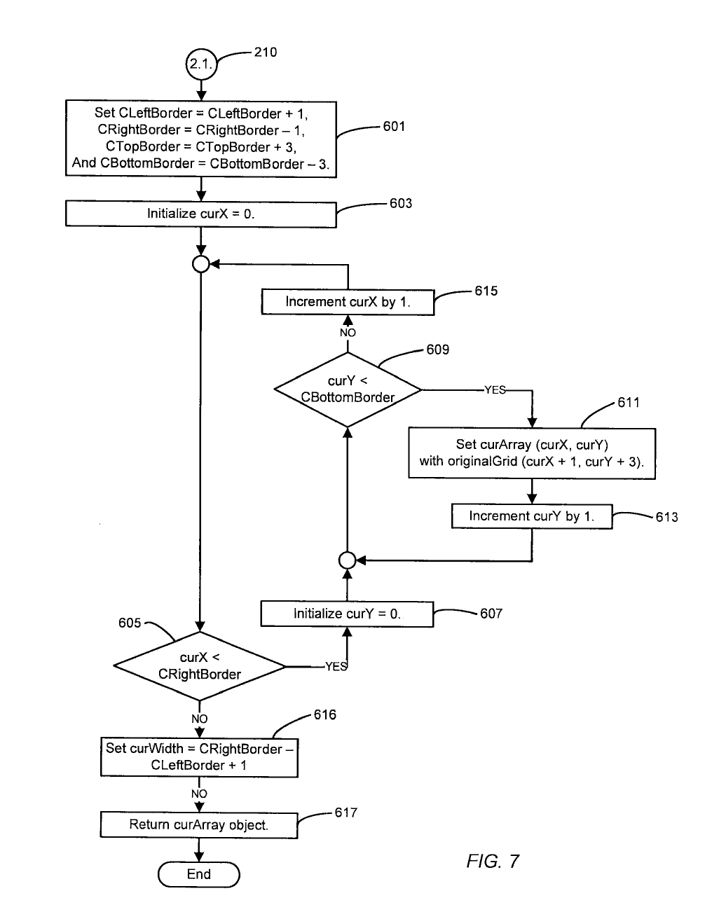

Continuing with FIG. 2, at step 13, the height of the area is determined at step 11, and is divided into four equal size rows, one row for each activity. The number of activities is pre-defined as indicated on the log sheet 6. A computational variable defined as curActivity is set to one. Another computational variable defined as ColString is set to empty. At step 15, the system determines whether curActivity is less than or equal to the number of rows, namely four in the present embodiment. If curActivity is less than or equal to four then, at step 17, the width of the area determined at step 11 is divided into quarters of an hour (based on a 24-hour graph), more particularly, into 96 columns, thereby establishing an array of 384 cells. Next, at step 19, subprocess 2 is performed to ascertain if a horizontal line is situated in any of the cells. Subprocess 2 includes subprocess 210 for generating unit arrays that correspond to a portion of each of the cells, and subprocess 220 for refining the detection of the strongest possible horizontal line per cell. Subprocess 2 and subprocesses 210 and 220 will be discussed in further detail with reference to FIGS. 7-9D.

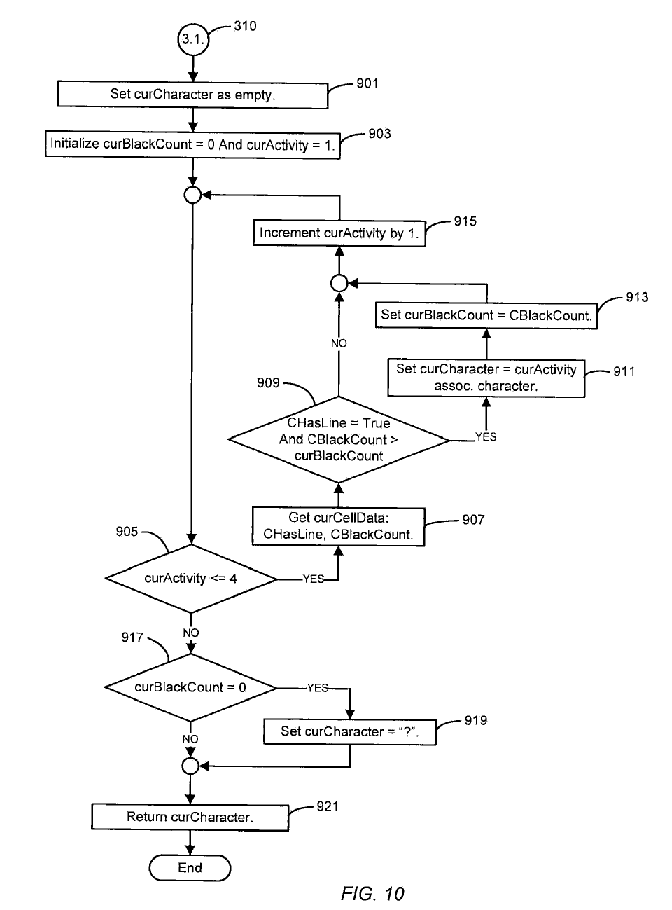

Returning now to FIG. 2, after step 19, curActivity is increased by 1 at step 21 and the system returns to step 15. If the system determines at step 15 that curActivity is less than or equal to four, the loop continues to cycle through steps 17, 19, and 21. If the system determines at step 15 that curActivity is not less than or equal to four, then at step 23, variable ColString is initialized to an initial character. At step 25, a loop begins with determining if a variable defined as curQuarterHour is less than or equal to 96. If curQuarterHour is less than or equal to 96, then the system proceeds at step 27 with subprocess 3 that compares each of the activities along the y-axis to determine which activity includes the cell with the strongest probability for a substantially horizontal line and populates a string variable with the identity of the activity associated with the line. Subprocess 3 and subprocess 310 are described in more detail with regard to FIG. 10. Returning to FIG. 2, at step 29 curQuarterHour is increased by 1 at step 29 when the system returns to the step 25. If the system determines at step 25 that curQuarterHour is not less than or equal to 96, then at step 31, the system returns the value for the 96 string variable.

Referring to FIG. 3, subprocess 110 performs the process of finding the actual left border of the graph 4 by looking for a vertical row of black pixels that extend to a height that is greater than the anticipated height of various other vertical lines in the graph 4 that do not constitute a border. Beginning at step 201, the width of the estimated graph area given by the four borders is divided by 96 (number of quarter hours in 24 hours) and setting a mini right border (RightBorder) twice as wide as the number obtained by this division. RightBorder is used along with the other three borders to define a new area to search for borders. At step 203, the system calculates two-thirds of the height of the resulting graph area from step 201 and sets this as the value of a computational variable minBlackCount. At step 205 a computational variable maxBlackCount is provided with a starting value of zero. At step 207, two computational variables potentialLeft and curVertical are set to the value for the left border.

At step 209, the system determines whether curVertical is less than the value for the RightBorder. If curVertical is less than RightBorder, then at step 211, the system counts the number of black pixels in curVertical by cycling from the top border to the bottom border. The number of black pixels is set as the value for the computational variable BlackCount. At step 213, the system determines whether BlackCount is greater than minBlackCount. If so, the system resets the value of potentialLeft to curVertical at step 215 and updates minBlackCount and maxBlackCount to equal BlackCount at step 217.

If the BlackCount is not greater than minBlackCount at step 213, or after the updating at step 217, the system queries at step 219 whether BlackCount is greater than maxBlackCount. If the step is true, then the system sets potentialLeft to equal curVertical at step 221 and updates maxBlackCount to equal BlackCount at step 223. Then, the system increments curVertical by one at step 225 and returns to step 209. If step 219 is false, then at step 227, the system queries to determine whether curVertical is greater than computational variable Left and maxBlackCount is equal to minBlackCount. If step 227 is true, then the system sets the Left Border to the current value of potentialLeft. If step 227 is not true, then the system increments curVertical by one at step 225 and returns to step 209.

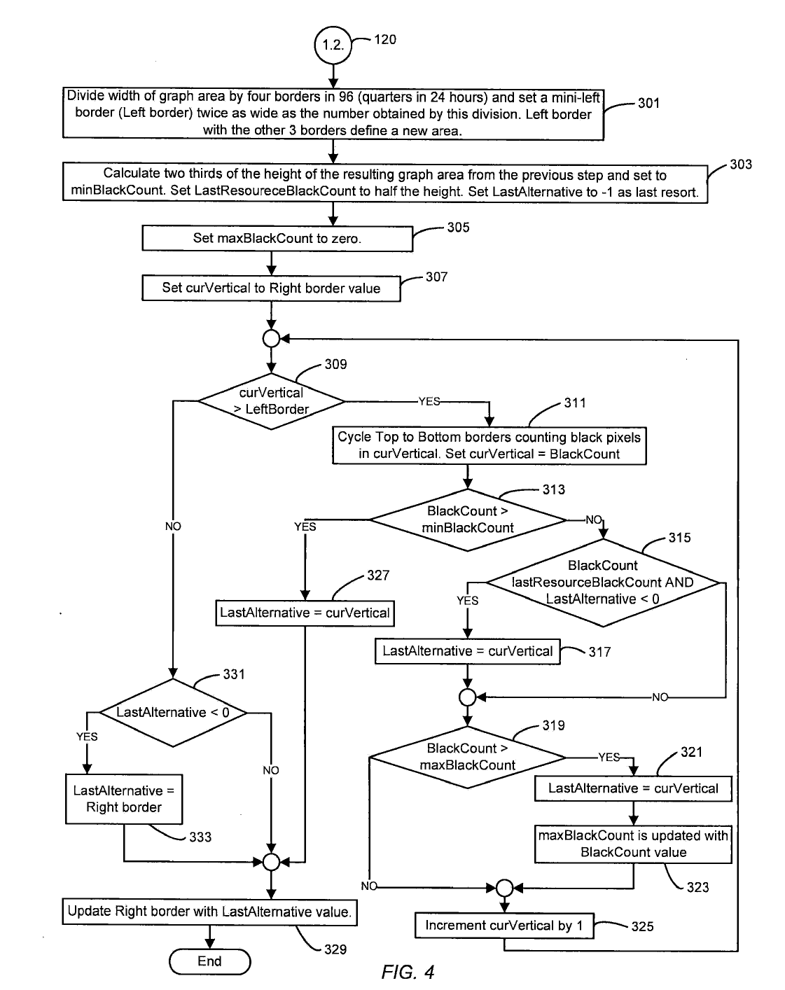

As shown in FIG. 4, the system next determines the right border of the graph 4 through subprocess 120. Subprocess 120 begins at step 301 by dividing the width of the graph area given by four borders into 96 (number of quarter hours in 24 hours) and sets a mini left border (LeftBorder) twice as wide as the number obtained by this division. LeftBorder is used along with the other three borders to define a new area to search for borders. At step 303, the system calculates two-thirds of the height of the resulting graph area from step 301 and sets this as the value of a computational variable minBlackCount. Further, the system calculates one-half of the height of the resulting graph area from step 301 and sets this as the value of a computational variable LastResourceBlackCount. Additionally, a computational variable LastAlternative is set to −1 (minus one) to serve as a last resort. At step 305 a computational variable maxBlackCount is provided with a starting value of zero. At step 307, computational variable curVertical are set to the value for the Right border.

At step 309, the system determines whether curVertical is greater than the value for the LeftBorder. If curVertical is greater than LeftBorder, then at step 311, the system counts the number of black pixels in curVertical by cycling from top to bottom borders. The number of black pixels is set as the value for the computational variable BlackCount. At step 313, the system determines whether BlackCount is greater than minBlackCount, if true, the system resets the value of LastAlternative to curVertical at step 327 and updates Right Border to equal the value of LastAlternative at step 329. If BlackCount is not greater than minBlackCount, then at step 315, the system queries whether both BlackCount is greater than LastResourceBlackCount and LastAlternative is greater than 0 (zero), if true, then the system resets LastAlternative to equal curVertical at step 317.

Following resetting LastAlternative at step 317, or if step 315 produced a false, the system proceeds to step 319 and queries whether BlackCount is greater than maxBlackCount. If true, then the system sets LastAlternative to equal curVertical at step 321 and updates maxBlackCount to equal BlackCount at step 323. Following either step 323 or if step 319 is false, the system increments curVertical by one at step 325 and returns to step 309. If step 309 is false, then at step 331, the system queries to determine whether LastAlternative is less than zero. If step 331 is true, the system sets variable LastAlternative to the value for the Right Border at step 333. Following step 333, or if step 331 is false, the system updates Right Border to equal the value of LastAlternative at step 329.

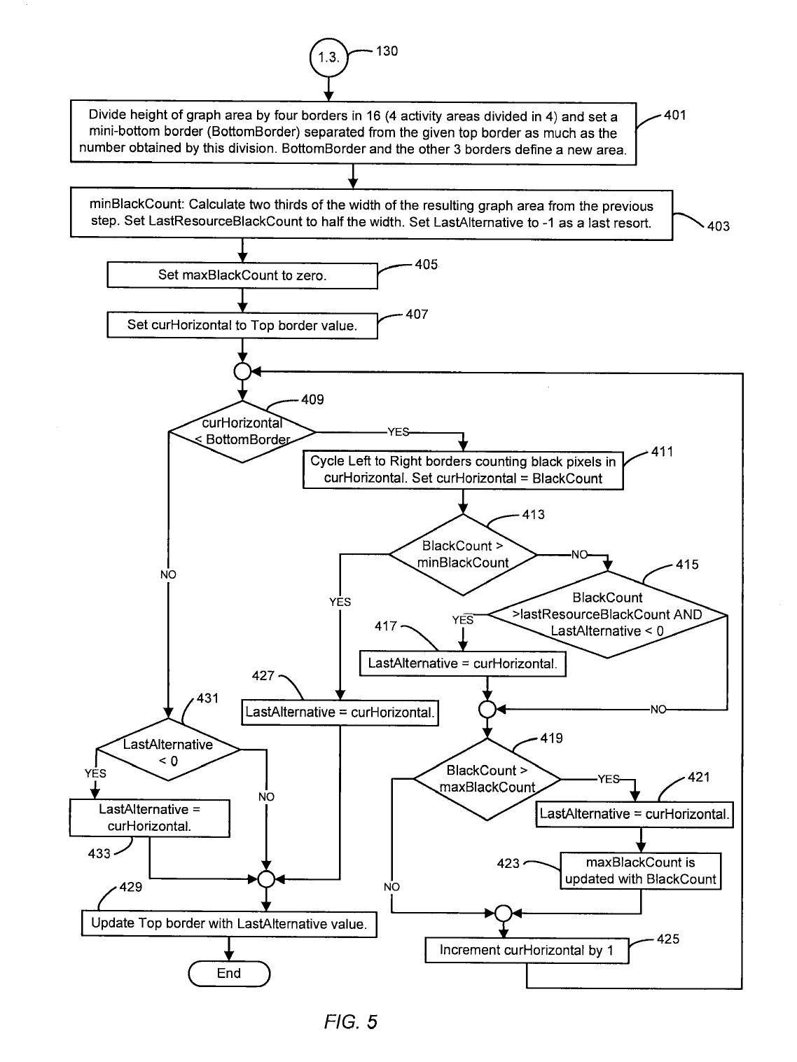

As shown in FIG. 5, the system next determines the Top border of the graph 4 through subprocess 130. Subprocess 130 begins at step 401 by dividing the height of the graph area given by four borders into 16 (4 activity areas divided by 4) and sets a mini bottom border (BottomBorder) at a point separated from the pre-defined top border twice as far as the number obtained by this division. BottomBorder is used along with the other three borders to define a new area to search for borders. At step 403, the system calculates two-thirds of the width of the resulting graph area from step 401 and sets this as the value of a computational variable minBlackCount. Further, the system calculates one-half of the width of the resulting graph area from step 401 and sets this as the value of a computational variable LastResourceBlackCount. Additionally, a computational variable LastAlternative is set to −1 (minus one) to serve as a last resort. At step 405 a computational variable maxBlackCount is provided with a starting value of zero. At step 407, computational variable curHorizontal is set to the value for the Top border.

At step 409, the system determines whether curHorizontal is greater than the value for the BottomBorder. If curHorizontal is greater than BottomBorder, then at step 411, the system counts the number of black pixels in curHorizontal by cycling from left to right borders. The number of black pixels is set as the value for the computational variable BlackCount. At step 413, the system determines whether BlackCount is greater than minBlackCount, if true, the system resets the value of LastAlternative to curHorizontal at step 427 and updates TopBorder to equal the value of LastAlternative at step 429. If at step 413 BlackCount is not greater than minBlackCount, then at step 415, the system queries whether both BlackCount is greater than lastResourceBlackCount and LastAlternative is greater than zero. If step 415 is true, then the system resets LastAlternative to equal curHorizontal at step 417. Following resetting LastAlternative at step 417, or if step 415 was false, the system queries 419 whether BlackCount is greater than maxBlackCount. If step 419 is true, then the system sets LastAlternative to equal curHorizontal at step 421 and updates maxBlackCount to equal BlackCount at step 423. Following either step 423 or if step 419 is false, the system increments curHorizontal by one at step 425 and returns to step 409. If step 409 is false, then at step 431, the system queries to determine whether LastAlternative is less than zero. If step 431 is true, then at step 433, the system sets variable LastAlternative to the value for the curHorizontal. Following step 433, or if step 431 is false, the system updates Top border to equal the value of LastAlternative at step 429.

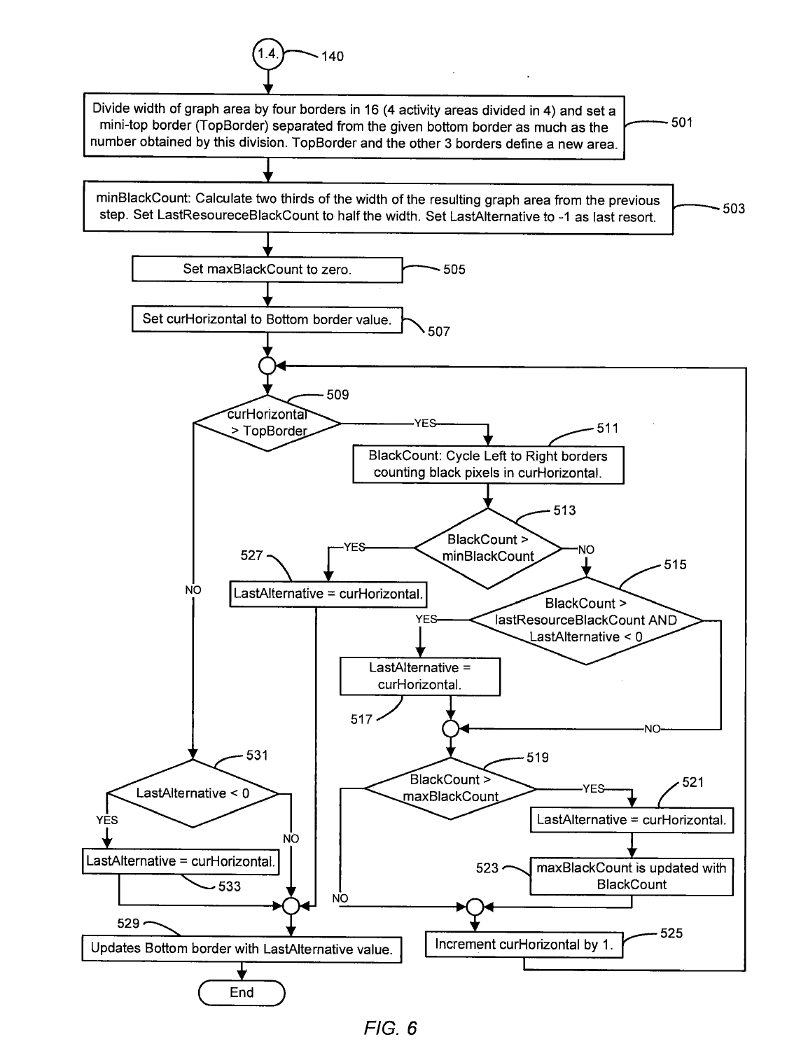

As shown in FIG. 6, the system next determines the Bottom border of the graph scan through subprocess 140. Subprocess 140 begins at step 501 by dividing the height of the graph area given by four borders into 16 (4 activity areas divided into 4) and sets a mini top border (TopBorder) separated from the pre-defined bottom border by an amount twice the number obtained by this division. TopBorder will be used with the other three borders define a new area. At step 503, the system calculates two-thirds of the width of the resulting graph area from step 501 and sets this as the value of a computational variable minBlackCount. Further, the system calculates one-half of the width of the resulting graph area from step 501 and sets this as the value of a computational variable LastResourceBlackCount. Additionally, a computational variable LastAlternative is set to −1 (minus one) to serve as a last resort. At step 505 a computational variable maxBlackCount is provided with a starting value of zero. At step 507, computational variable curHorizontal is set to the value for the Bottom border.

Further, at step 509, the system determines whether curHorizontal is greater than the value for the TopBorder. If curHorizontal is greater than TopBorder, then at step 511, the system counts the number of black pixels in curHorizontal by cycling from left to right borders. The number of black pixels is set as the value for the computational variable BlackCount. At step 513, the system determines whether BlackCount is greater than minBlackCount. If step 513 is true, the system resets the value of LastAlternative to curHorizontal at step 527 and updates BottomBorder to equal the value of LastAlternative at step 529. If at step 513 the BlackCount is not greater than minBlackCount, then at step 515, the system queries whether both BlackCount is greater than lastResourceBlackCount and LastAlternative is greater than zero. If step 515 is true, then the system resets LastAlternative to equal curHorizontal at step 517.

Following resetting LastAlternative at step 517, or if step 515 was false, at step 519, the system queries whether BlackCount is greater than maxBlackCount. If step 519 is true, then the system sets LastAlternative to equal curHorizontal at step 521 and updates maxBlackCount to equal BlackCount at step 523. Following either step 523 or step 519 being false, the system increments curHorizontal by one at step 525 and returns to step 509. If step 509 is false, the system queries 531 to determine whether LastAlternative is less than zero. If step 531 is true, the system sets variable LastAlternative to the value for the curHorizontal at step 533. Following step 533, or if step 531 is false, the system updates Bottom Border to equal the value of LastAlternative at step 529.

Returning to FIG. 2, once the actual borders of the graph 4 have been determined in subprocesses 110, 120, 130, and 140, the system at step 17, determines the height and width of the graph 4 and divides the graph area into rows and columns. In the present embodiment, for the graph 4, the height is divided into 4 equal rows and the width is divided into 96 equal columns, creating a total of 384 cells each having a unit array of pixels therein. Each of the cells is bordered by a series of pixels situated along the axes of the graph 4 and therefore each cell has a border that can be identified by pixel coordinates along the axes. For example, if each cell includes 10 pixels along its width and 30 pixels along its height, a first cell would have a Left-Border (x-axis) at 0, a Right-Border (x-axis) at 9, a Top-Border (y-axis) at 0, and a Bottom-Border (y-axis) at 29. In addition, a second cell, located to the right of the first cell would have a Left-Border at 10, a Right-Border at 19, a Top-Border at 0, and a Bottom-Border at 29. Further, a third cell located below the first would have a Left-Border at 0, a Right-Border at 9, a Top-Border at 30, and a Bottom-Border at 39.

Continuing now to step 19, the system starts to capture the probability of a substantially horizontal line being present in each of the cells through subprocesses 210 and 220. To find the probability of a line in each cell, the pixels in the cells are analyzed to identify if they are black and this information is communicated to a generated array. In the present embodiment, to minimize error, only a central portion of each cell is analyzed. As discussed in detail below, a modified version of the array for each cell is established, namely curArray, which relates the pixel information located in a central portion of each cell to units in curArray, where the units are formed by the intersecting rows and columns in curArray. Each black pixel detected in the cell generates a representative black pixel indicator which is used to populate curArray. In addition, although curArray is formed from a central portion of the cell array, the units, formed by the intersections of unit rows and unit columns in curArray, start at an x-axis value of zero and a y-axis value of zero.

FIG. 7 shows a flowchart of subprocess 210, which in the present embodiment is used to establish the curArray for each cell, which is used in step 220. Using the borders identified in step 11, the borders for each cell are defined by the demarcations established by steps 13 and 17. Therefore, after steps 13 and 17, each cell has a CLeftBorder, a CRightBorder, a CTopBorder and a CBottomBorder. Using this border information for each cell, at step 601, the system resets computational variables: CLeftBorder to CLeftBorder+1; CRightBorder to CRightBorder−1; CTopBorder to CTopBorder+3; and CBottomBorder to CBottomBorder−3. Resetting the borders in this manner effectively eliminates the edge portions of the cell when generating curArray, as the edge portions may provide undesirable black pixel indications based on residual border pixels. In addition, subprocess 210 populates curArray with the black pixel indicator, for example, a “1” when a black pixel is detected in the corresponding location in the cell, and a “0” when no black pixel is detected. The indicators are then analyzed in subprocess 220 to establish the probability of a substantially horizontal line.

As shown in FIG. 2, subprocess 210 is preceded by step 208 that detects if curQuarterHour is less than or equal to 96. In addition, subprocess 220 is succeeded by step 222 that increments the value for curQuarterHour by 1. Referring now to FIG. 7, in subprocess 210, at step 603, the system initializes computational variable curX to zero. At step 605, the system queries whether curX is less than CRightBorder. If step 605 is true, the computational variable curY is initialized to zero at step 607. Then at step 609, the system queries whether curY is less than the CBottomBorder. If step 609 is true, the system sets computational variable curArray (curX,curY) to originalGrid (curX+1, curY+3) at step 611, where originalGrid includes the X and Y coordinates of the cells before truncation. Next the system increments curY by one (step 613) and returns to step 609. When step 609 is false, the system increments curX by one at step 615 and returns to step 605. When step 605 is false, then the system at step 616 sets curWidth equal to CRightBorder−CleftBoarder+1, and at step 617, the system returns the value for curArray, where the borders for recently configured curArray are designated as ATopBorder, ABottomBorder, ALeftBorder, and ARightBorder.

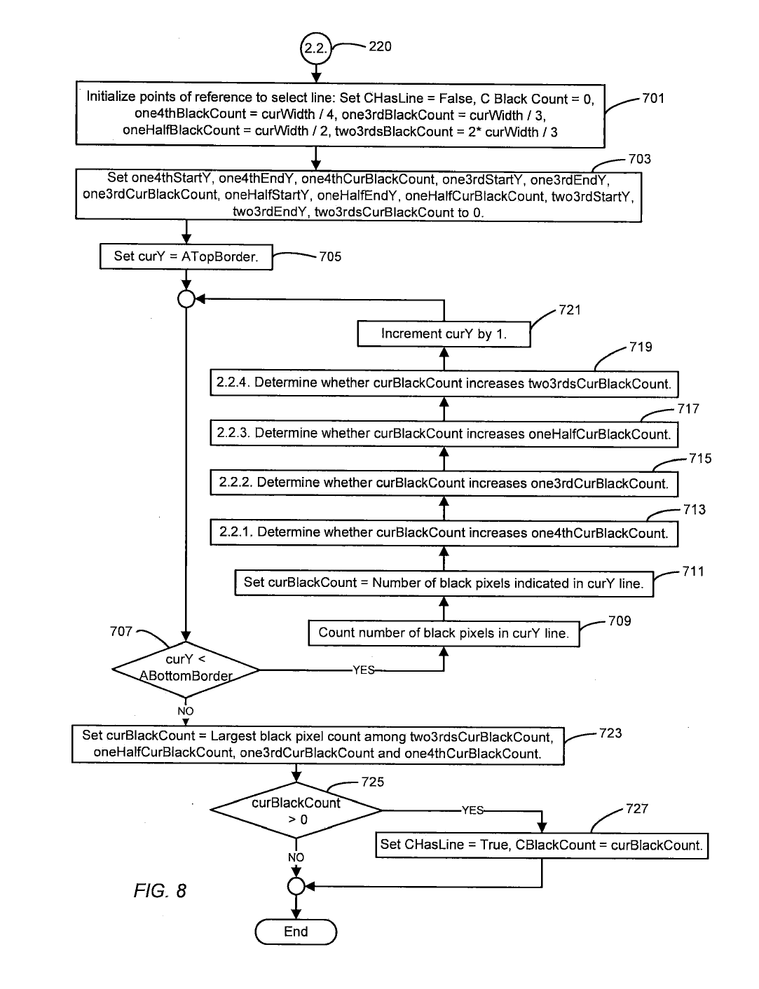

FIG. 8 shows a flowchart for subprocess 220. In subprocess 220, in the present embodiment, each unit row of curArray is analyzed to identify the potential for a substantially horizontal line extending across at least a portion of the row. Occasionally, a graph image will include a line that, although intended to be horizontal, has been drawn at least partially diagonal, thereby crossing successive unit rows, in another occurrence, a line may drawn in broadly thereby occupying a series of unit rows to overshadow another incorrect line. Further, in another occurrence, a line may not extend the full length of a unit row, although it was intended to. To accommodate for these and other potential occurrences, variable counters are established for counting the black pixel indicators that represent incremental portions of a line, for example, in the present embodiment, the incremental portions include one-quarter, one-third, one-half, and two-thirds of the pixel row. In addition, start and end counters for each incremental portion are provided that detect if a line appears to end at one unit row and then continue on the next unit row. If it is determined that a line has been detected in one or more unit rows, whether horizontal, diagonal, or partial, a counter is set to true for that unit and the number of black pixels associated with the line (the strength) is provided for later comparison with other units. The largest incremental portions detected (strength of the lines) for each unit in a time column are then compared to determine which unit has the greatest possibility of a line therethrough (i.e. the largest strength), thereby indicating which activity row form the associated cell is indicated for that time period.

Referring again to FIG. 8, at step 701, the system initializes points of reference for analyzing the unit rows. Variables CHasLine (the computational variable used to flag whether a particular unit indicates a potential line) is set at false and CBlackCount is set to zero, where CBlackCount will carry the strength of the line indication found in the unit for comparison with other units. As discussed above, various incremental portions of a potential line can be detected by incrementally analyzing portions of a unit row. In the present embodiment, the strength of a potential line is measured along four increments, namely, one4thBlackCount=curWidth/4, one3rdBlackCount=curWidth/3, oneHalfBlackCount=curWidth/2, and two3rdsBlackCount=2*curWidth/3. After setting the increments at step 701, then at step 703, the system intializes the values of one4thStartY, one4thEndY, one3rdStartY, one3rdEndY, oneHalfStartY, oneHalfEndY, two3rdsStartY, two3rdsEndY, one4thCurBlackCount, one3rdCurBlackCount, oneHalfCurBlackCount and two3rdsCurBlackCount all to zero. At step 705, the value of curY is set to equal the value of ATopBorder for the current cell array being analyzed. The system, at step 707, then queries whether the value for curY is less than or equal to the value of ABottomBorder for the current cell array.

If step 707 is true, then at step 709, the system counts the number of black pixel indicators in the curY line, and in step 711, sets this number as the value for curBlackCount. At steps 713, 715, 717, and 719, the system determines whether curBlackCount increases the value of one4thCurBlackCount, one3rdCurBlackCount, oneHalfCurBlackCount and two3rdsCurBlackCount, respectively. This determination is discussed in more detail below and adjusts those values accordingly. The system then increments curY by one and returns to step 707.

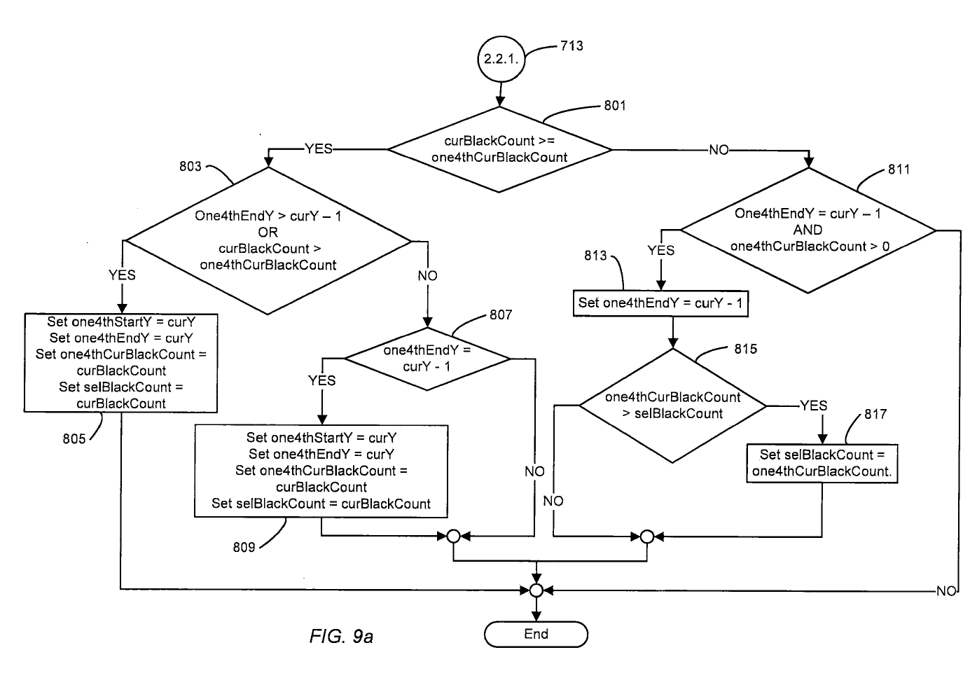

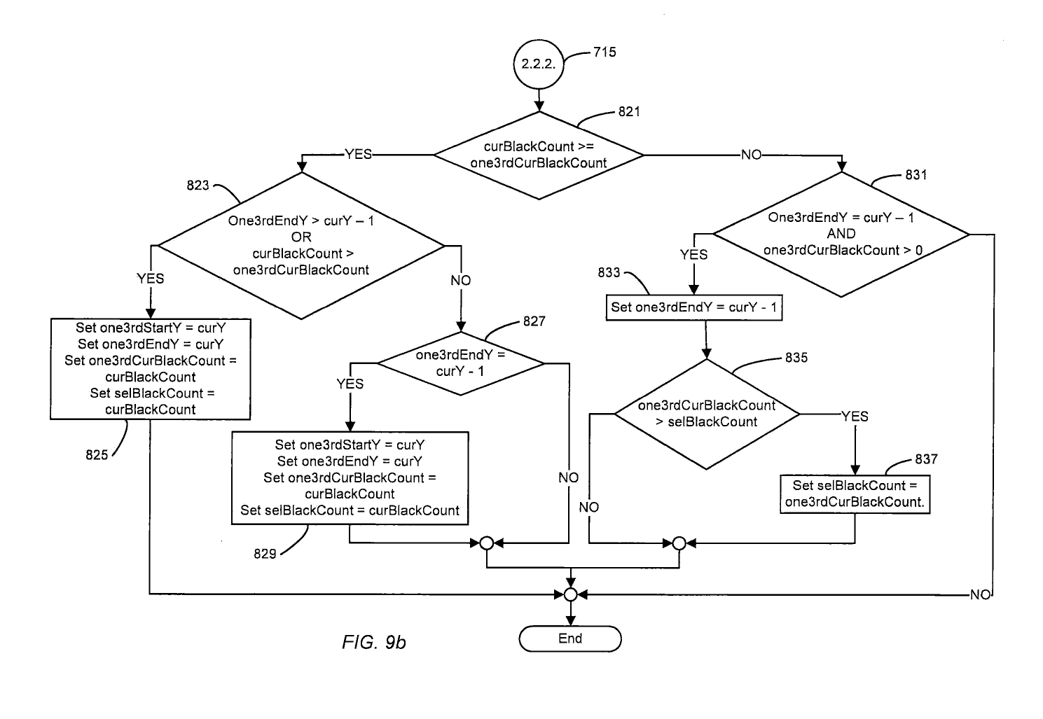

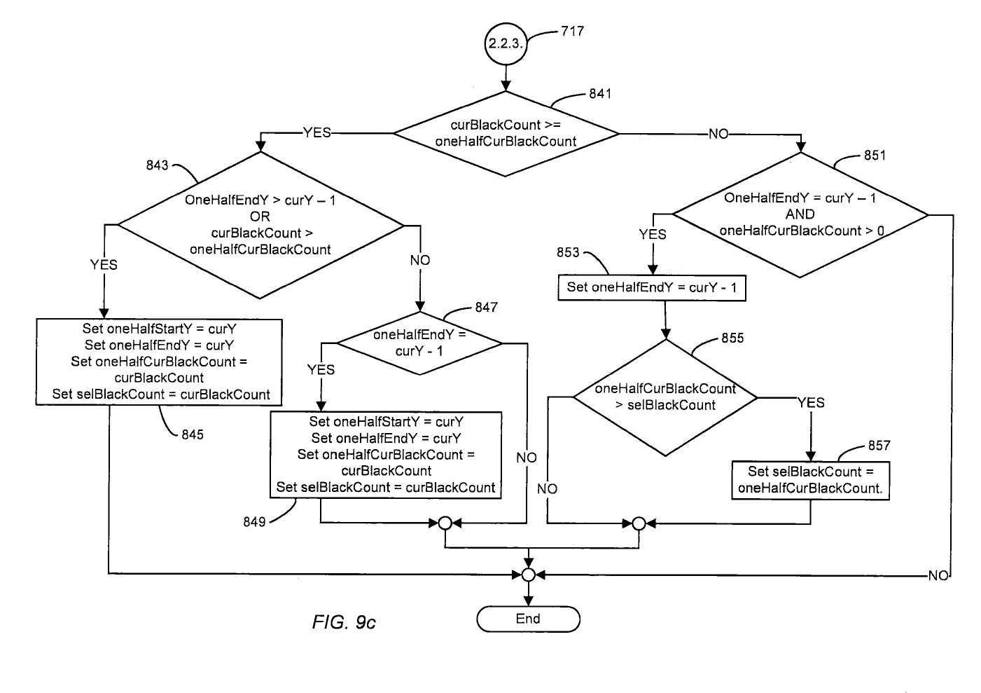

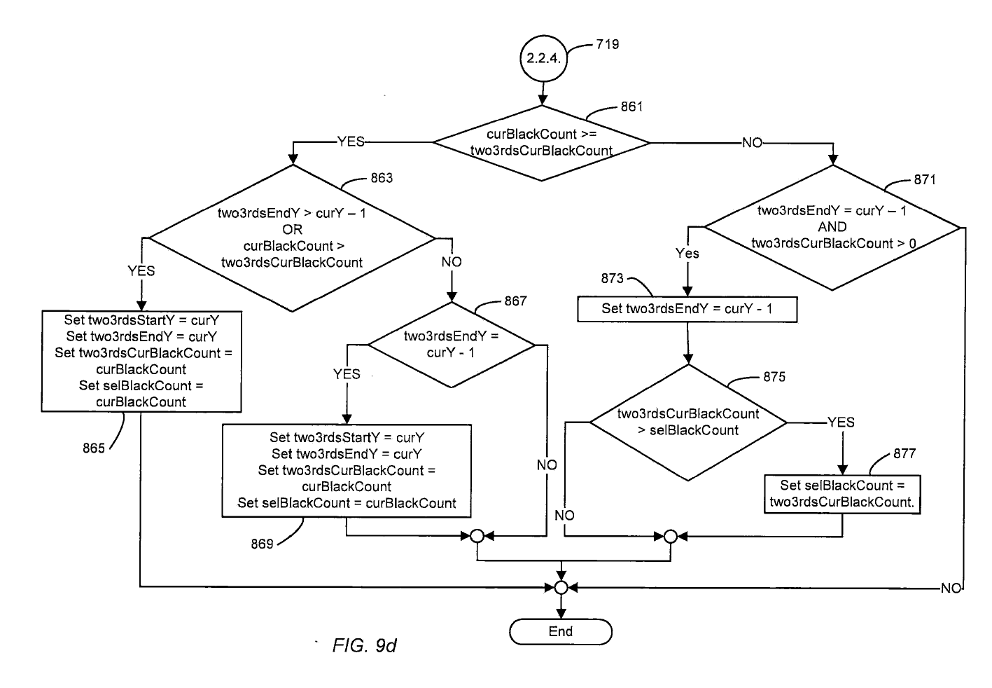

FIGS. 9A, 9B, 9C, and 9D show the details of the determinations of steps 713, 715, 717, and 719, respectively, for the present embodiment. Referring to FIG. 9A (step 713), at step 801, the system queries whether curBlackCount is greater or equal to one4thCurBlackCount. If step 801 is true, then at step 803, the system queries whether either one4thEndY is greater than curY−1 or curBlackCount is greater than one4thCurBlackCount. If step 803 is true, then at step 805, the system sets one4thStartY to curY, one4thEndY to curY, one4thCurBlackCount to curBlackCount and selBlackCount to curBlackCount and step 713 ends. If step 803 is false, then at step 807, the system queries whether one4thEndY equals curY−1. If step 807 is true, the system at step 809 sets one4thStartY to curY, one4th EndY to curY, one4thCurBlackCount to curBlackCount and selBlackCount to curBlackCount and step 713 ends. If step 807 is false, step 713 ends without resetting any variables.

If step 801 is false, then at step 811, the system queries whether both one4thEndY equals curY−1 and one4thCurBlackCount is greater than zero. If step 811 is true, at step 813, the system sets ine4thEndY to equal curY−1 and at step 815 queries whether one4thCurBlackCount then is greater than selBlackCount. If step 815 is true, then at step 817, the system sets selBlackCount to equal one4thCurBlackCount and step 713 ends. If step 815 is false, step 713 ends without resetting selBlackCount.

Referring to FIG. 9B (step 715), at step 821, the system queries whether curBlackCount is greater or equal to one3rdCurBlackCount. If step 821 is true, then at step 823, the system queries whether either one3rdEndY is greater than curY−1 or curBlackCount is greater than one3rdCurBlackCount. If step 823 is true, at step 825, the system sets one3rdStartY to curY, one3rd EndY to curY, one3rdCurBlackCount to curBlackCount and selBlackCount to curBlackCount and step 715 ends. If step 823 is false, then at step 827, the system queries whether one3rdEndY equals curY−1. If step 827 is true, at step 829, the system sets one3rdStartY to curY, one4th EndY to curY, one3rdCurBlackCount to curBlackCount and selBlackCount to curBlackCount and step 715 ends. If step 827 is false, step 715 ends without resetting any variables.

If step 821 is false, then at step 831, the system queries whether both one3rdEndY equals curY−1 and one3rdCurBlackCount is greater than zero. If step 831 is true, at step 833, the system sets one3rdEndY to equal curY−1 and at step 835, queries whether one3rdCurBlackCount then is greater than selBlackCount. If step 835 is true, then at step 837, the system sets selBlackCount to equal one3rdCurBlackCount and step 715 ends. If step 835 is false, step 715 ends without resetting selBlackCount.

Referring to FIG. 9C (step 717), at step 84, the system queries whether curBlackCount is greater or equal to oneHalfCurBlackCount. If step 841 is true, then at step 843, the system queries whether either oneHalfEndY is greater than curY−1 or curBlackCount is greater than oneHalfCurBlackCount. If step 843 is true, at step 845, the system sets oneHalfStartY to curY, oneHalf EndY to curY, oneHalfCurBlackCount to curBlackCount and selBlackCount to curBlackCount and step 717 ends. If step 843 is false, then at step 847, the system queries whether oneHalfEndY equals curY−1. If step 847 is true, at step 849, the system sets oneHalfStartY to curY, oneHalfEndY to curY, oneHalfCurBlackCount to curBlackCount and selBlackCount to curBlackCount and step 717 ends. If step 847 is false, step 717 ends without resetting any variables.

If step 841 is false, at step 851, the system queries whether both oneHalfEndY equals curY−1 and oneHalfCurBlackCount is greater than zero. If step 851 is true, then at step 853, the system sets oneHalfEndY to equal curY−1 and at step 855, queries whether oneHalfCurBlackCount then is greater than selBlackCount. If step 855 is true, then at step 857, the system sets selBlackCount to equal oneHalfCurBlackCount and step 717 ends. If step 855 is false, step 717 ends without resetting selBlackCount.

Referring to FIG. 9D (step 719), at step 861, the system queries whether curBlackCount is greater or equal to two3rdsCurBlackCount. If step 861 is true, then at step 863, the system queries whether either two3rdsEndY is greater than curY−1 or curBlackCount is greater than two3rdsCurBlackCount. If step 863 is true, at step 865, the system sets two3rdStartY to curY, two3rdsEndY to curY, two3rdsCurBlackCount to curBlackcount, and selBlackCount to curBlackCount, and step 719 ends. If step 863 is false, then at step 867, the system queries whether two3rdsEndY equals curY−1. If step 867 is true, at step 869, the system sets two3rdsStartY to curY, two3rdsEnd Y to curY, two3rdsCurBlackCount to curBlackcount, and selBlackCount to curBlackCount, and step 719 ends. If step 867 is false, step 719 ends without resetting any variables.

If step 861 is false, then at step 841, the system queries whether both two3rdsEndY equals curY−1 and two3rdsCurBlackCount is greater than zero. If step 871 is true, at step 873, the system sets two3rdsEndY to equal curY−1 and at step 875, queries whether two3rdsCurBlackCount then is greater than selBlackCount. If step 875 is true, then at step 877, the system sets selBlackCount to equal two3rdsCurBlackCount and step 719 ends. If step 875 is false, step 719 ends without resetting selBlackCount.

Returning to FIG. 8, if step 707 is false, then at step 723, the system sets curBlackCount to equal the largest black count among one4thCurBlackCount, one3rdCurBlackCount, oneHalfCurBlackCount, and two3rdsCurBlackCount. Then at step 725, the system queries whether curBlackCount is greater than zero. If step 725 is true, at step 727, the system sets CHasLine to true to flag the potential presence of a line in the corresponding cell and records the strength of that line by setting CBlackCount to the curBlackCount value. If step 725 is false, the system leaves CHasLine in the default false value.

Referring now to FIG. 10, using the information generated by analyzing the unit arrays, the process looks to identify which corresponding cells may have a line therethrough. In particular, step 310 includes the process for determining for each time column which activity row has the greatest possibility of a line, and generating a character to represent that activity row and appending that character to a string which represents the length of time spent on each activity for all the time periods. In the present embodiment, the system begins character generation at step 901 by setting the curCharacter variable as empty. Then at step 903, the system initializes curBlackCount to zero and curActivity to one. At step 905, the system queries whether curActivity is less than or equal to 4 (for the illustrated embodiment where the log has 4 activities). If step 905 is true, then at step 907, the system retrieves the current cell data for CHasLine and CBlackCount. The system then proceeds to determine which cell for a particular activity has the strongest potential line at step 909 by querying whether both CHasLine is true and CBlackCount is greater than curBlackCount. If step 909 is true, at step 911, the system sets curCharacter to the character associated with the current activity. At step 913, the system sets curBlackCount to equal the value of CBlackCount. The combination of steps 909 and 913 prevents the system from changing the character unless another cell has a stronger probability for the presence of a line. After step 913, or if step 909 is false, then at step 915, the system increments curActivity by 1 and returns to step 905.

If step 905 is false (i.e., all possible activities have been evaluated), at step 917, the system queries whether curBlackCount equals zero, which would indicate that the cell for that particular activity had a zero probability of a line. If step 917 is true, then at step 919, the system sets the curCharacter to a question mark to flag that the activity for that time period could not be determined. After step 919, or if step 917 is false, at step 921, the system returns the value of curCharacter to be appended to the character string. As the character string includes an identifier representing which one of the activities was identified as containing a line for each quarter hour increment, the system can total the time associated with each activity and provide an output to a user on one or more of various forms.

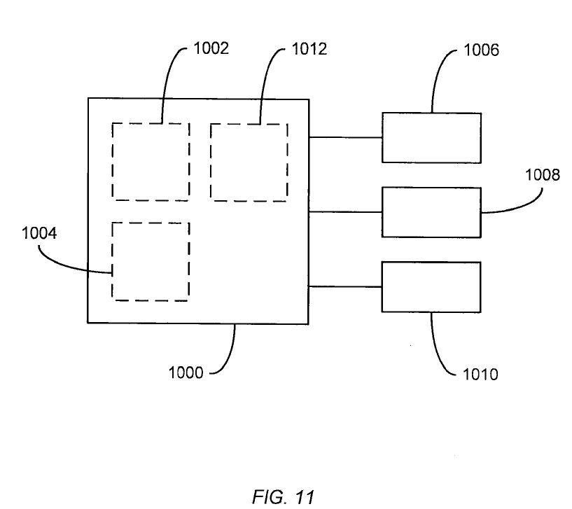

One exemplary system is shown in FIG. 11 and includes a computer 1000 with a processing unit 1002 programmed with a rules engine 1004 capable of executing all of the desired steps of the process and providing all of the desired functions as described above. The processing unit is in electronic communication with a database 1006 capable of storing the graphical images to be analyzed as described herein. More particularly, in addition to the processing unit 1002 for executing program steps, the computer 1000 can include one or more input devices 1008, one or more output devices 1010, and a memory 1012 for receiving and storing data from the input devices, transmitting data to the output devices, and storing program steps for program control and manipulating data in memory.

The method of the invention can be in the form of software which is run on the system shown in FIG. 11. The method disclosed herein is preferably performed by means of the computer 1000. The computer, through the input devices 1008, receives electronic image data files, such as obtained from physical operator logs, and stores the electronic image data files in the memory 1012. The computer 1000, through the processing unit 1002, executes the program steps to: assign a unique identifier to the electronic image data file; manipulate the electronic image data files to locate and adjust the borders of the image; divide the area of the image into cells; determine the probability of a line in each cell; determine which cell has the strongest probability of a line for each segment of the x-axis; select a character based on the cell with the strongest probability and append that character to a character string. The computer 1000 transmits the character string to an output device 1010 or to a database 1006 for further processing.

In at least some embodiments, the input and output devices 1008, 1010, can include computer terminals, email devices and/or Internet access devices. Communications with the input and output devices 1008, 1010 can be through one or more servers (not shown) connected to an intranet, the Internet, or both. In addition, the system may be a further part of a system for processing operator log documents as described in co-pending application titled “METHOD AND SYSTEM FOR PROCESSING OPERATOR LOG DOCUMENTS” filed on the same date as this application and incorporated herein by reference in its entirety.

It is specifically intended that the present invention not be limited to the embodiments and illustrations contained herein, but include modified forms of those embodiments including portions of the embodiments and combinations of elements of different embodiments as come within the scope of the following claims.

We claim:

1. A method for extracting discrete driver input activity information from an analog graph on a driver log sheet, the method comprising:
providing an electronic image of at least a portion of the log sheet that includes the analog graph;
identifying a graph height dimension and a graph width dimension;
dividing the height dimension into a number of activity rows, each activity row representing a respective activity performed by a driver;
dividing the width dimension into a number of time columns to represent a number of time frames for performing the activities, thereby establishing an array of cells defined by the intersections of the time columns and the activity rows, where each cell includes a plurality of pixels;
determining for each cell a probability that a substantially horizontal line formed by black pixels extends substantially across at least a portion of that cell, wherein the black pixels represent driver input activity information;
for each time column, comparing the respective probabilities of the cells in that time column, flagging the cell with the highest probability, and determining the activity row of the flagged cell, thereby determining which activity was performed in each time frame.

2. The method of claim 1, further including for at least one activity row, summing the flagged cells in that activity row to generate a time duration for the activity represented by that activity row.

3. The method of claim 1, wherein the identifying further comprises identifying the locations of left, right, top and bottom borders of the analog graph, thereby defining the graph height dimension between the top and bottom borders, and the graph width dimension between the left and right borders.

4. The method of claim 3, wherein identifying a graph height dimension and a graph width dimension further comprises evaluating pre-determined anticipated top and bottom borders along each of their lengths to determine for each if a series of black pixels are continuous along the length for at least a substantial portion of the anticipated border length, and evaluating predetermined anticipated left and right borders along each of their heights to determine for each if a series of black pixels are continuous along the height for at least a substantial portion of the anticipated border height.

5. The method of claim 1 further comprising generating a plurality of unit arrays each having a plurality of units formed by intersecting unit rows and unit columns, wherein each cell has a corresponding unit array, with at least a portion of each of the cell pixel locations corresponding to respective units.

6. The method of claim 5, wherein each unit array includes a top border, bottom border, left border and right border, and at least a portion of the corresponding cell pixels are discounted when constructing corresponding unit arrays.

7. The method of claim 6 further comprising populating the unit arrays with black pixel indicators for each unit identifying if the corresponding cell pixel is black.

8. The method of claim 7 further comprising summing the numbers of black pixel indicators in each unit row.

9. The method of claim 8 further comprising populating variables that include the highest black pixel indicator count for the unit rows in the unit array, wherein the variables include the highest black pixel indicator count determined at various incremental portions along the unit rows extending from a left border to a right border of the unit array.

10. The method of claim 9, wherein the various incremental portions include at least one of, one-fourth, one-third, one-half, and two-thirds, the length of a unit row.

11. The method of claim 8, wherein populating the variables further comprises summing the black pixel indicator count for various incremental portions along the unit rows in the unit arrays, where the total number of black pixels indicators in an uninterrupted series of unit rows, which each contain at least one black pixel indicator, are summed together to provide a strength number for at least one of the incremental portions, where the strength number indicates the probability of a line in that incremental portion.

12. The method of claim 11 further comprising comparing the strength numbers for each of the incremental portions analyzed in the unit array to identify the largest strength number for the unit array as a whole.

13. The method of claim 1, wherein determining which activity was performed in each time frame includes generating a respective character to represent each activity and generating a character string including respective characters corresponding to each time frame.

14. A method of calculating a probability that a line extends through a portion of a graph, the method comprising:
providing at least a portion of a graph having a cell that includes a first array of pixels, where the first array has a plurality of first rows and a plurality of first columns;
generating a second array having a plurality of units formed by intersecting second rows and second columns, wherein at least a portion of the units correspond with pixel locations in the first array, with the quantity of second rows being less than the quantity of first rows, and the quantity of second columns being less than the quantity of first columns;
populating each unit in the second array with an indicator to identify if a black pixel is detected in the corresponding pixel location of the cell; and
summing the number of black pixel indicators in each second row to determine the probability of a line.

15. The method of claim 14, wherein the first array includes a top border, bottom border, left border and right border, and at least a portion of the first rows and first columns situated adjacent to the borders do not correspond to any second row and second column in the second array.

16. The method of claim 15 further comprising populating variables that include the highest black pixel indicator count for the second rows in the second array, wherein the variables include the highest black pixel indicator count determined at various incremental portions along the length of the second rows.

17. The method of claim 16, wherein the various incremental portions include at least one of, one-fourth, one-third, one-half, and two-thirds, the length of a second row.

18. The method of claim 17, wherein populating the variables further comprises summing the black pixel indicator count for various incremental portions along the second rows, where the total number of black pixel indicators in an uninterrupted series of second rows that each contain at least one black pixel indicator, are summed together to provide a strength number for at least one of the incremental portions, where the strength number indicates the probability of a line situated in the corresponding first array.

19. The method of claim 18 further comprising comparing the strength numbers for each of the incremental portions analyzed in the second array to identify the largest strength number for the second array.

20. The method of claim 19, wherein the first array represents a potential activity performed by a driver during a period of time.

21. The method of claim 15 further comprising populating at least one variable that includes the highest black pixel indicator count for one or more second rows to provide a strength number, where the strength number equals the black pixel indicator count and is used to indicate the probability of a line situated in the corresponding cell.

22. A computer system for extracting driver input activity information from an analog graph on a driver log sheet, the system comprising:
an input portion for receiving an electronic image of at least a portion of the log sheet that includes the analog graph, the image having a plurality of pixels, each pixel having an associated value;
a processor portion for analyzing the pixel values of the image to determine the actual borders of the graph, and subsequently calculate a graph height dimension and a graph width dimension, wherein the height dimension is divided into a pre-determined number of activity rows to represent a number of possible activities performed by an operator and the width dimension is divided into a number of time columns to represent a number of time frames for performing the activities, thereby establishing a first array of cells defined by the intersections of the activity columns and the time rows, where each cell is populated with respective pixels, and wherein the probability that a substantially horizontal line formed by black pixels extends substantially across at least a portion of each cell is determined, and for each time column, the respective probabilities of the cells in that time column are compared, and the cell with the highest probability is flagged and the activity row of the flagged cell is determined, thereby determining which activity was performed in each time frame; and
an output portion for displaying or otherwise providing an accounting of the activity that was performed in each time frame.
